(19) United States
(12) Patent Application Publication
(10) Pub. No.: US 2006/0210277 A1
(43) Pub. Date: Sep. 21, 2006

(54) Method and arrangement for the wireless control of a device, in particular in the field of medicine

(76) Inventors: Steffen Dubnack, Jena (DE); Martin Wiechmann, Jena (DE)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(21) Appl. No.: 11/090,580

(22) Filed: Mar. 24, 2005

(30) Foreign Application Priority Data
Mar. 31, 2004 (DE) 10 2004 015 679.4
Mar. 22, 2005 (DE) 10 2005 013 063.1

(51) Int. Cl. H04B 10/00

(52) U.S. Cl. 398/106

(57) ABSTRACT

Method and arrangement for the wireless control of a device, in particular in the field of medicine. The present invention is directed to a solution for the operation of devices to be controlled, wherein signals required for controlling and monitoring are transmitted wirelessly. In the arrangement for the wireless control of a device, the control is carried out by a separate operating unit. The operating unit and the device to be controlled each have their own transmitting unit and receiving units. Signals are sent from the transmitting unit of the device to be controlled at a high repeat rate. The operating unit is activated by these signals and generates its power supply therefrom. Coded signals are generated by the operating unit for the different operating commands and sent to the device to be controlled. The solution that was developed for medical instruments can also be applied to many other technical fields. This type of operating console can be used very flexibly because it has no troublesome cables. Due to the absence of an internal power supply, it can be used continuously and for long periods of time.

### CROSS-REFERENCE TO RELATED APPLICATIONS

This application claims priority of German Application No. 10 2004 015 679.4, filed Mar. 31, 2004 and German Application No. 10 2005 013 063.1, filed Mar. 22, 2005, the complete disclosures of which are hereby incorporated by reference.

### BACKGROUND OF THE INVENTION

a) Field of the Invention

The present invention is directed to a solution for the operation of devices to be controlled, in particular microscopes or surgical microscopes. When operation is carried out primarily by means of a foot switch console, the signals required for controlling and monitoring are transmitted wirelessly.

b) Description of the Related Art

According to the known prior art, the necessary adjustments, particularly in surgical microscopes, are realized by means of operating units that are usually constructed as foot switch consoles. As a rule, these foot switch consoles are connected to the surgical microscope by power cables and data cables. An example is the surgical microscope described in U.S. Pat. No. 5,048,941. On one hand, the power cables and data cables leading to the foot switch console limit the freedom of movement of the surgeon; there is a risk of tripping over the cables. On the other hand, malfunctions in transmission can occur due to the constant mechanical stress. In addition, the cables present an additional source of contamination that makes it more difficult to meet prescribed hygienic requirements.

EP 1 329 757 describes a transmission device by which the control signals of a surgical microscope can be transmitted without power cables or data cables. In this way, control data and/or measurement data, e.g., zoom, focus, working distance, positioning, tilting angle, and so on, can be transmitted bidirectionally from the operating unit to the microscope. The cordless transmission can be carried out in analog or digitally by electromagnetic radiation, infrared radiation or ultrasonic radiation. Range limiting, directional transmission and/or partial shielding prevents other devices from being influenced.

Another solution for wireless transmission of monitoring signals and/or control signals between an operating unit and a surgical microscope unit is described in EP 196 32 281. The operating unit can be constructed for foot actuation or hand actuation. In this case, more than one operating unit, e.g., one for an operator and one for an assistant, can be connected to the surgical microscope. For this purpose, the design of the operating units is adapted to their various tasks. While both operating units retain the same functions, one operating unit is assigned a priority function in executing the signals. The operating units and the surgical microscope each have a transmitting unit and a receiving unit for transmitting the monitoring signals and/or control signals. The transmission is preferably carried out by means of electromagnetic waves because transmission interference can occur due to obstacles when transmitting by infrared radiation or ultrasonic radiation.

The aforementioned solutions are disadvantageous in that the operating unit must have an internal power supply, e.g., a battery, for carrying out data transmission. This results in additional problems such as monitoring the charge of the battery and recharging the battery. Nevertheless, a mains connection may also be provided for the operating unit if necessary in order to keep the device ready to operate at all times and also to carry out long operations without problems. The advantage of wireless transmission of the monitoring signals and/or control signals is accordingly negated.

It is the object of the present invention to develop a solution by which a medical device and its wireless operating unit can be used immediately, continuously and over a long period of time without additional technical expenditure.

According to the invention, this object is met by the features of the independent claims. Preferred further developments and constructions are the subject matter of the dependent claims.

The proposed solution was developed for medical instruments, in particular for surgical microscopes, which are generally controlled by operating consoles, preferably for foot-controlled operation.

But the solution can also be used in other technical fields in which devices are to be operated by input means or control means. The operating unit can be constructed as a normal operating console or in another form.

The invention will be described more fully in the following with reference to embodiment examples.

### BRIEF DESCRIPTION OF THE DRAWING

In the drawing:

FIG. 1 shows a schematic of the arrangement according to the invention for wireless control of a device.

### DESCRIPTION OF THE PREFERRED EMBODIMENTS

In the method for wireless control of a device, in particular in the field of medicine, the control is carried out by means of a separate operating unit. The operating unit and the device to be controlled each have their own transmitting and receiving units.

Signals of suitable frequency are sent at a high repeat rate by the transmitting unit of the device to be controlled to activate the operating unit. The operating unit generates its power supply from the repeatedly emitted signals of the device to be controlled and is capable of sending coded signals to the device to be controlled for realizing different operating commands.

In the method for wireless control, the transmission of the signals is preferably carried out in the visible or adjacent infrared range at a wavelength between 400 nm and 3 μm or at frequencies in the radio wave range between 100 kHz and 10 GHz.

The operating unit, which is preferably based on RFID (Radio Frequency Identification) technology, can be programmed wirelessly and is capable of storing data.

The English-language expression “radio frequency identification” (abbreviated RFID) is a method by which data can be read and/or stored without physical or visible contact. In principle, an arrangement for realizing RFID technology provides an antenna, an analog switching circuit for reception and transmission (transponder), a digital switching circuit, and a permanent storage. The corresponding characteristic numbers such as radio frequency, transfer rate, cost per unit, useful life, storage space and range of functions vary depending upon the area of application.

The coded signals sent by the operating unit are so shaped that the device to be controlled is capable of detecting transmission errors and correcting them if necessary. For this purpose, after receiving a coded signal of the operating unit, the device to be controlled sends a test signal back to the operating unit. This test signal is compared in the operating unit to the coded signal originally sent. After evaluating this comparison, the operating unit sends another signal to the device to be controlled, which signal confirms the correct transmission or rejects it.

In another development, it is possible to allow various devices to be controlled to communicate with different operating units, a unique assignment being carried out by means of a corresponding coding of the signals. The assignment between the device to be controlled and operating unit is changeable.

In an advantageous application of the method according to the invention, the device to be controlled is a medical instrument. For example, wireless operation of a surgical microscope can be carried out by means of a foot-actuated operating console which frees the hands of the operator. Surgical microscopes in particular can also be controlled by means of a plurality of operating consoles which are preferably constructed for foot actuation. It is possible for all operating consoles to have equality of access, or the settings of the operator's operating console can have priority.

In the arrangement, according to the invention, for wireless control of a device 10, particularly in the field of medicine, the control is carried out by means of a separate operating unit 20. Both the operating unit 20 and the device 10 to be controlled have their own transmitting units 11 and 21 and receiving units 12 and 22.

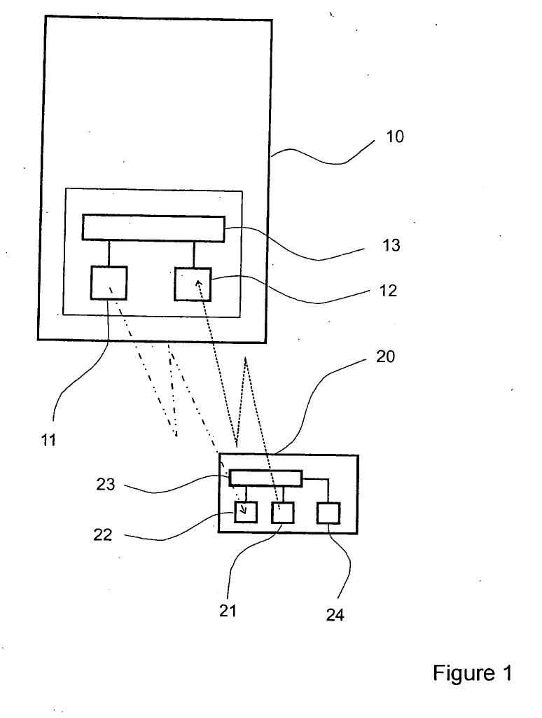

FIG. 1 shows a schematic of the arrangement, according to the invention, for wireless control of a device.

Signals of suitable frequency are sent at a high repeat rate by the transmitting unit 11 of the device 10 to be controlled to activate the operating unit 20. The operating unit 20

generates its power supply from the repeatedly emitted signals of the transmitting unit 11 of the device 10 to be controlled in that the signals are received by the reception unit 22. The operating unit 20 has a control unit 23 for generating coded signals for different operating commands. These coded signals are sent from the transmitting unit 21 of the operating unit 20 to the reception unit 12 of the device 10 to be controlled.

In the arrangement for wireless control, the transmission of the signals is preferably carried out in the visible or adjacent infrared range at a wavelength between 400 nm and 3 μm or at frequencies in the radio wave range between 100 kHz and 10 GHz.

The operating unit, which is preferably based on RFID (Radio Frequency Identification) technology, has at least one permanent storage which can preferably be programmed wirelessly.

The coded signals sent by the transmitting unit 21 of the operating unit 20 are so shaped that the device 10 to be controlled is capable of receiving them by means of its receiving unit 12 and detecting and/or correcting transmission errors in its control unit 13. For this purpose, after receiving a coded signal of the operating unit 20, the transmitting unit 11 of the device 10 to be controlled sends a test signal back to the receiving unit 22 of the operating unit 20. This test signal is compared in the control unit 23 of the operating unit 20 to the coded signal originally sent. Another signal which confirms the correct transmission or rejects it is then sent from the transmitting unit 21 of the operating unit 20 to the receiving unit 12 of the device 10 to be controlled.

In another development, it is possible to allow various devices to be controlled to communicate with different operating units, a unique assignment being carried out by means of a corresponding coding of the signals. The assignment between the device to be controlled and operating unit is changeable.

It is particularly advantageous when an operating unit 20 has at least one permanent storage 24 which can preferably be programmed wirelessly. In this way, it is possible to adapt the operating unit 20 for use with different devices 10 to be controlled.

In an advantageous application of the inventive method, the device 10 to be controlled is a medical instrument. For example, wireless operation of a surgical microscope can be carried out by means of a foot-actuated operating console which frees the hands of the operator. Surgical microscopes in particular can also be controlled by means of a plurality of operating consoles which are preferably constructed for foot actuation. It is possible for all operating consoles to have equality of access, or the settings of the operator's operating console can have priority.

The solution according to the invention is used for bidirectional, wireless transmission of monitoring signals and/or control signals between one or more operating units and at least one device to be controlled.

In the proposed solution, the energy from the transmission signals is used to generate and transmit signals for control from actions of the operator, whereas the transponder technology known from the prior art is used exclusively for identification. This leads to a large range of possible uses. For example, in addition to the use of wireless operation of a surgical microscope, use for wireless transmission of signals between peripheral devices such as a keyboard, mouse, pointer stylus, or the like, and a computer is also conceivable.

The solution according to the invention offers a range of technical advantages. For example, the operating consoles can be used very flexibly; they have no troublesome cables and no transmission interference occurs due to obstacles. The operating consoles can be used continuously and over a long period of time because they have no internal power supply.

While the foregoing description and drawings represent the present invention, it will be obvious to those skilled in the art that various changes may be made therein without departing from the true spirit and scope of the present invention.

What is claimed is:

1-22. (canceled)

23. A method for the wireless control of a device, in particular in the field of medicine, comprising the steps of:
providing a separate operating unit, said device and operating unit each having its own transmitting unit and receiving unit; and
generating power supply for the operating unit from the repeatedly emitted signals received by its receiving unit from a transmitting unit of the device to be controlled and being capable of transmitting coded signals to the device to be controlled by its transmitting unit for realizing different operating commands.

24. The method for wireless control according to claim 23, wherein the signals are transmitted in the visible or adjacent infrared region with a wavelength between 400 nm and 3 μm and the operating unit generates its power supply from the signals of the device to be controlled.

25. The method for wireless control according to claim 23, wherein the signals are transmitted in the radio wave range between 100 kHz and 10 GHz and the operating unit generates its power supply from the signals of the device to be controlled.

26. The method for wireless control according to claim 25, wherein the operating unit is based on RFID (Radio Frequency Identification) technology.

27. The method for wireless control according to claim 23, wherein the operating unit is preferably programmable in a wireless manner and stored data.

28. The method for wireless control according to claim 23, wherein the coded signal transmitted by the transmitting unit of the operating unit is shaped in such a way that the device to be controlled is capable of receiving it by its receiving unit and detecting and/or correcting transmission errors.

29. The method for wireless control according to claim 23, wherein, after receiving a coded signal of the operating unit, the device to be controlled sends a test signal back to the receiving unit of the operating unit, said test signal being compared in the control unit of the operating unit to the coded signal originally sent, and the transmitting unit of the operating unit sends another signal to the device to be controlled, which signal confirms the correct transmission or rejects it.

30. The method for wireless control according to claim 23, wherein different devices to be controlled can communicate with different operating units and are uniquely associated with one another by means of a corresponding coding of the signals.

31. The method for wireless control according to claim 23, wherein the assignment between the device to be controlled and the operating unit is changeable.

32. The method for wireless control according to claim 23, wherein the device to be controlled is a medical instrument.

33. The method for wireless control according to claim 23, wherein the operating unit is foot-actuated.

34. An arrangement for the wireless control of a device, in particular in the field of medicine, comprising:
a separate operating unit;
said device and operating unit each having its own transmitting unit and receiving unit; and
said operating unit generating its power supply from the repeatedly emitted signals received by its receiving unit from the transmitting unit of the device to be controlled and being capable of transmitting coded signals to the receiving unit of the device to be controlled by means of the transmitting unit.

35. The arrangement for wireless control according to claim 34, wherein the transmitting units and receiving units are based on transmission in the visible or adjacent infrared region with a wavelength between 400 nm and 3 μm and the operating unit generates its power supply from the signals of the device to be controlled.

36. The arrangement for wireless control according to claim 34, wherein the transmitting units and receiving units are based on transmission in the radio wave range between 100 kHz and 10 GHz and the operating unit generates its power supply from the signals of the device to be controlled.

37. The arrangement for wireless control according to claim 35, wherein the operating unit is based on RFID (Radio Frequency Identification) technology.

38. The arrangement for wireless control according to claim 34, wherein the operating unit has at least one permanent storage which can preferably be programmed wirelessly.

39. The arrangement for wireless control according to claim 34, wherein the coded signal transmitted by the transmitting unit of the operating unit is shaped in such a way that the device to be controlled is capable of receiving it by its receiving unit and detecting and/or correcting transmission errors in the control unit.

40. The arrangement for wireless control according to claim 34, wherein, after receiving a coded signal of the operating unit, a test signal is sent back to the receiving unit of the operating unit by the transmitting unit of the device to be controlled, this test signal is compared in the control unit of the operating unit to the coded signal originally sent, and the transmitting unit of the operating unit sends another signal to the receiving unit of the device to be controlled, which signal confirms the correct transmission or rejects it.

41. The arrangement for wireless control according to claim 34, wherein different devices to be controlled can communicate with different operating units by means of their transmitting units and receiving units and are uniquely associated with one another by means of a corresponding coding of the signals.

42. The arrangement for wireless control according to claim 34, wherein the assignment between the device to be controlled and the operating unit is changeable.

43. The arrangement for wireless control according to claim 34, wherein the device to be controlled is a medical instrument.

44. The arrangement for wireless control according to claim 34, wherein the operating unit is a foot switch console.
